(19) United States
(12) Patent Application Publication
(10) Pub. No.: US 2007/0005692 A1
(43) Pub. Date: Jan. 4, 2007

(54) System for instant collaboration

(76) Inventors: Rodney Gist, Fullerton, CA (US); Robert Juracka, Frankfort, IL (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/155,100

(22) Filed: Jun. 18, 2005

(51) Int. Cl. G06F 15/16

(52) U.S. Cl. 709/204

(57) ABSTRACT

A method comprising identifying data that is needed by a collaborator to complete a workflow process; creating a temporary access login and password to allow the collaborator temporary authentication and login ability; notifying the collaborator by a communication method that their participation is required to complete process; receiving a login and a password from the collaborator to access specific area of and inputs requested data; and, providing notification of completion of the collaborator by a second communication method.

### FIELD

The present invention relates generally to a information management system usable in insurance marketing and policy management systems, and more particularly, to a system for instant collaboration.

### BACKGROUND

There is a need for a comprehensive customer relationship management, sales force automation, and business management solution for insurance agencies. From sales and service to accounting and financial management and carrier/third party integration, one issue is the need for collecting information in many portions of the process workflows from one or more other parties. Typically, this needs to be done by a user sending out facsimiles, e-mails, or postal mail; or, in the alternative, telephoning or physically contacting the individuals or entities that have the information necessary to procure the information.

### SUMMARY

The present invention provides a system for instant collaborator (IC) provides a system for “Users” (e.g., Agency Representatives) to securely identify, contact and obtain needed data from “Collaborators” (e.g., Insureds, 3rd Party Data Source) for any specific workflow process within an insurance marketing and policy management system. In preferred embodiment, the system operates as follows:

1. User engaged in workflow identifies that data is needed by a Collaborator to complete process.

2. User creates temporary access login and password to allow Collaborator temporary (Time Limited) authentication and login ability to IC system.

3. Collaborator is notified by specified communication method (email, text message etc.) that their participation is required to complete process.

4. Collaborator uses login and password to access a specific area and inputs requested data.

5. User is notified of Collaborator process completion by specified communication methods.

Other features and advantages will become apparent to those skilled in the art from the following detailed description. It is to be understood, however, that the detailed description and specific examples, while indicating exemplary embodiments , are given by way of illustration and not limitation. Many changes and modifications within the scope of the following description may be made without departing from the spirit thereof, and the description should be understood to include all such modifications.

### BRIEF DESCRIPTION OF THE DRAWINGS

The invention may be more readily understood by referring to the accompanying drawings in which:

FIG. 1 is a block diagram of the instant collaboration (IC) system within an insurance marketing and policy management system configured in accordance with one embodiment of the present invention;

FIG. 2 is a block diagram of a computer system usable in the IC system, configured in accordance with one embodiment of the present invention;

FIG. 3 is a flow diagram describing an operation of the IC system in accordance with one preferred embodiment of the present invention;

FIG. 4 is a graphical user interface of a screen to log into an insurance marketing and policy management system, configured in accordance with one embodiment of the present invention;

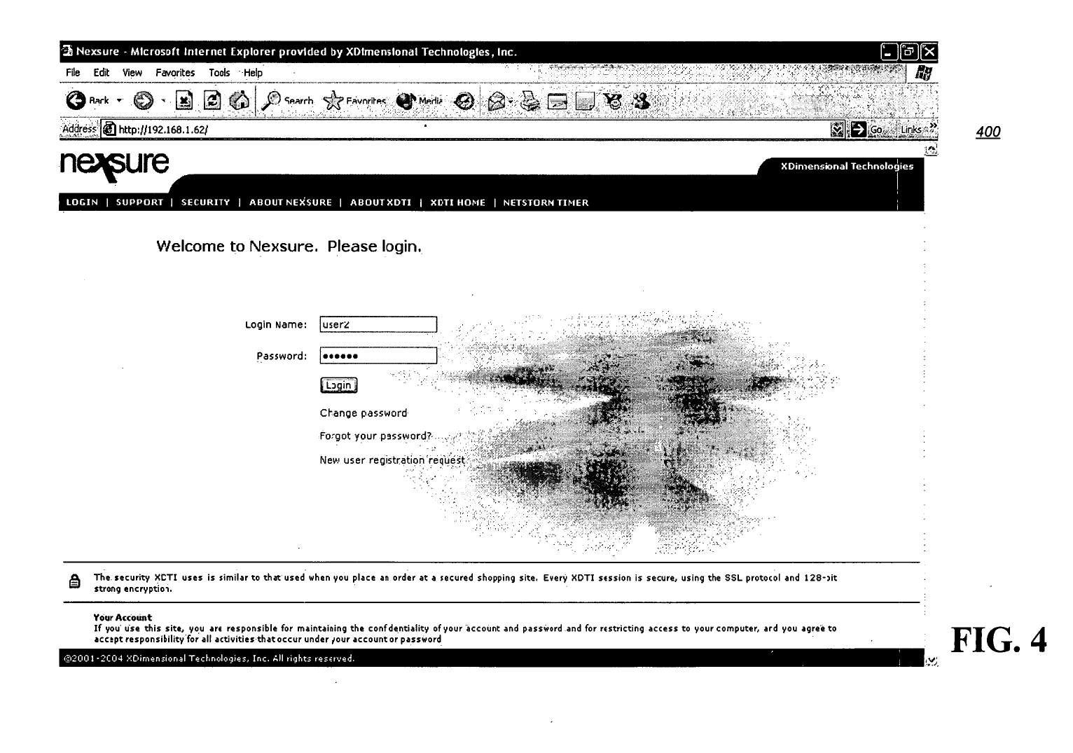

FIG. 5 is a graphical user interface of a menu to select a workflow in the insurance marketing and policy management system, configured in accordance with one embodiment of the present invention;

FIG. 6 is a graphical user interface of a screen to access the IC system from within the insurance marketing and policy management system, configured in accordance with one embodiment of the present invention;

FIG. 7 is a graphical user interface of a screen to select one or more collaborators in the IC system, configured in accordance with one embodiment of the present invention; and,

FIG. 8 is a graphical user interface of an input screen for collaborators in the IC system, configured in accordance with one embodiment of the present invention.

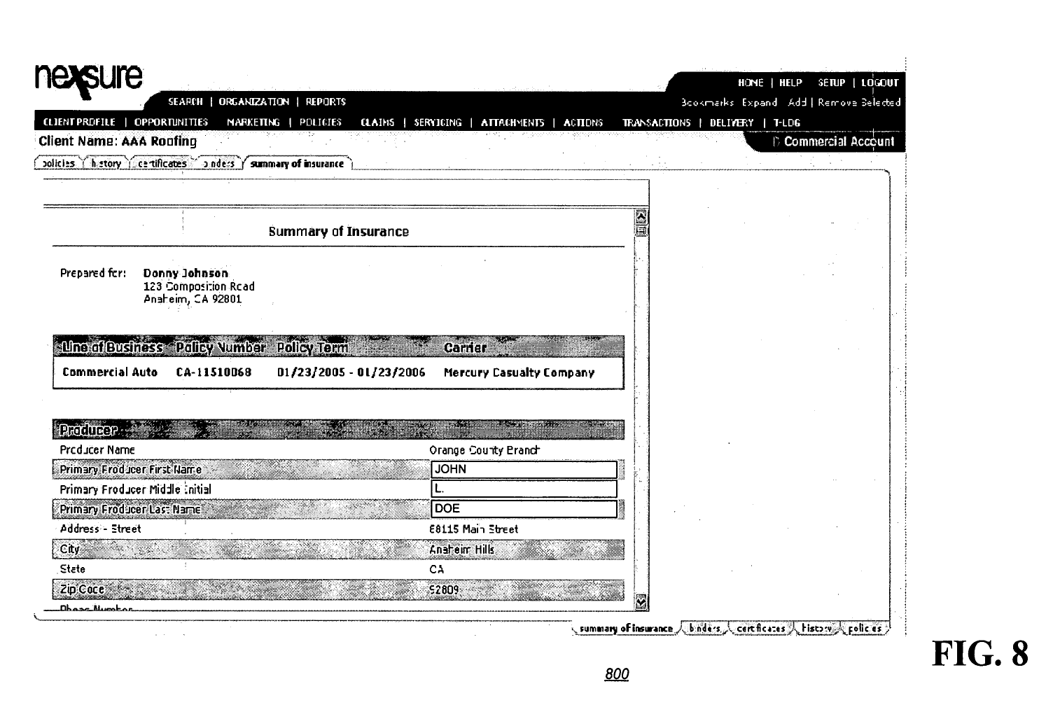

Like numerals refer to like parts throughout the several views of the drawings.

### DETAILED DESCRIPTION

The present invention, referred to as the Instant Collaborator (IC) system, provides a method for an individual such as an insurance agent from an insurance agency (user), to securely identify, contact and obtain needed data from other entities (collaborators). In one embodiment, collaborators can include:
An insured entity
Internal entities such as a department
3rd party data sources

For any specific workflow process within an insurance marketing policy management system such as:
Marketing
   Policy Underwriting
   Policy Remarketing
Policy Management
   Servicing a Policy
   Binders—Adding a binder to a Policy
   Edit—Correcting issues on a Policy
   Cancellations—Completing a Lost Policy Release form or identifying a policy that is pending Cancellation
   Claims—Generating a claim form
   Audits—Posting an audit
   Endorsements—Processing Endorsements on a Policy
   Renewals—Renewing a policy when it is due.
   Certificates—Creating and renewing certificates
   Verification—Generating verification of coverage forms, such as Auto ID cards.

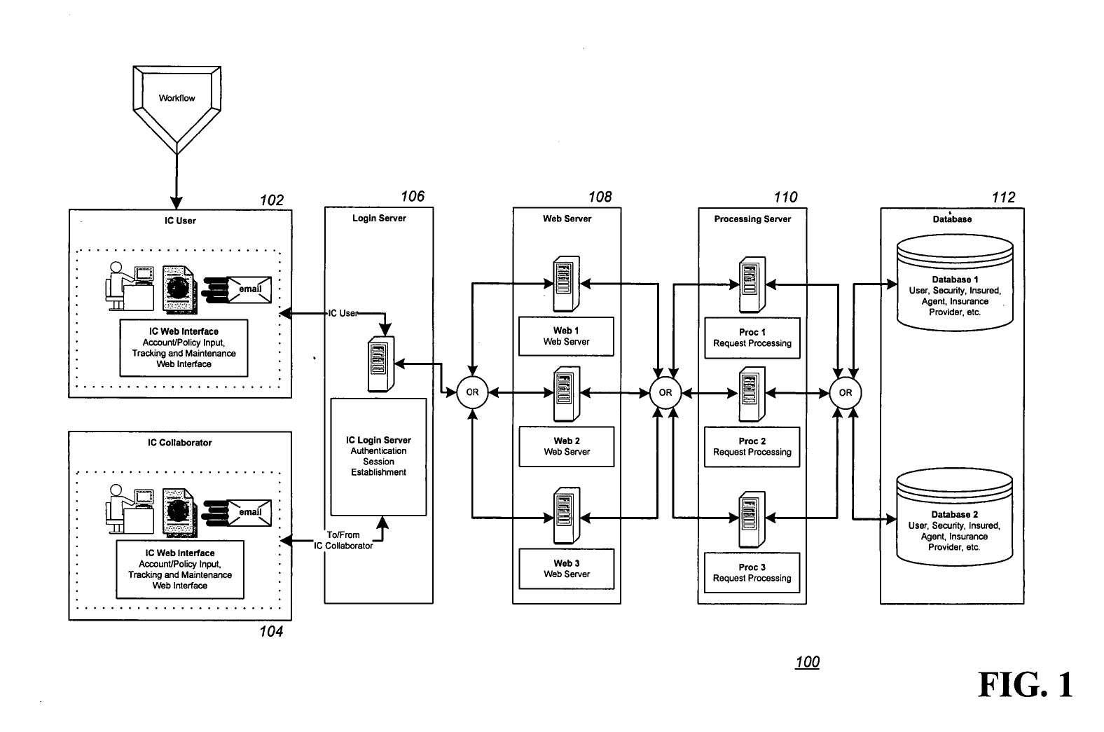

FIG. 1 illustrates an exemplary embodiment of an instant collaboration (IC) system in an insurance marketing and policy management system 100. System 100 includes a plurality of databases 112 storing information related to user information, security information for the system, as well as information pertaining to the insured, agents, providers/underwriters, etc. System 100 also includes a plurality of web servers 108 stores the instructions necessary to access and present the information retrieved from, as well as store information into, plurality of databases 112. A user 102, using a client computer such as a client 200, accesses server system 108 through a login server 106 to communicate with a collaborator 104, as further discussed below. A plurality of processing servers 110, will be coupled to web server 108. In the illustrated embodiment, the network used for communication between the servers represents a variety of networks that may include one or more local area networks as well as wide area networks. The functionality provided by the servers storing databases 112, plurality of processing servers 110, plurality of web servers 108, login server 106 and the computer used by user 102 and collaborator 104, as well as any other computer systems needed to implement the system described herein may be implemented using a computer system having the characteristics of a computer system as described above. It should be noted, however, that the specific implementation of the computer system or systems used to describe the present invention is not to be limiting unless otherwise specifically noted. For example, the functionality provided by login server 106 and plurality of web servers 108 may be combined in one computer system. Further, the functionality provided by database server 302 and 304 may be redistributed over several computers.

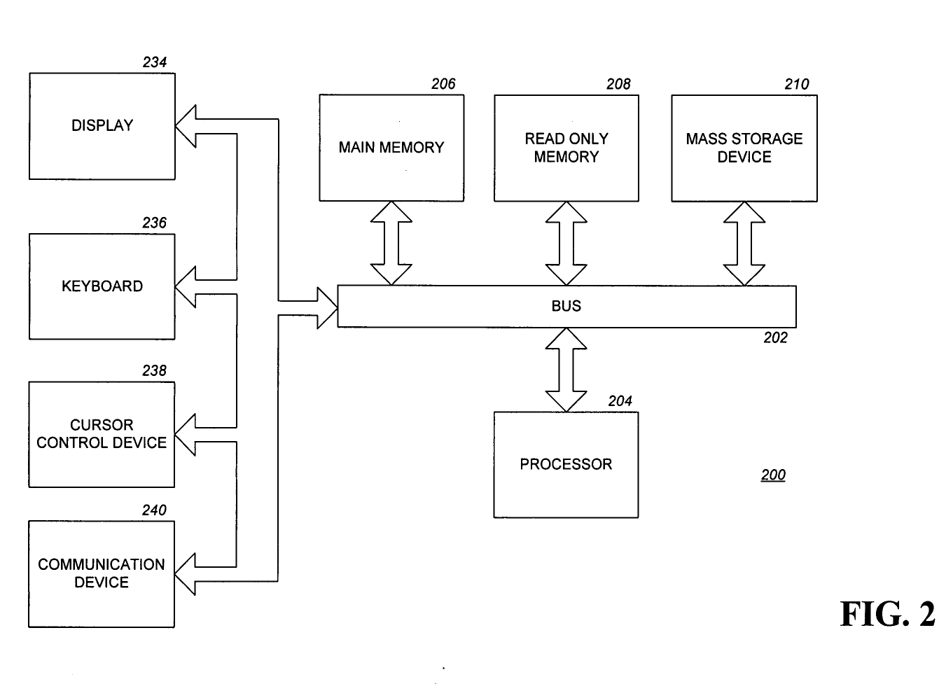

FIG. 2 illustrates an example of a computer system 200 in which the features of the present invention may be implemented. The computer system 200 includes a bus 202 for communicating information between the components in the computer system 200, and a processor 204 coupled with the bus 202 for executing software code, or instructions, and processing information. The computer system 200 further comprises a main memory 206, which may be implemented using random access memory (RAM) and/or other random memory storage device, coupled to the bus 202 for storing information and instructions to be executed by the processor 204. The main memory 206 also may be used for storing temporary variables or other intermediate information during execution of instructions by the processor 204. The computer system 200 also includes a read only memory (ROM) 208 and/or other static storage device coupled to the bus 202 for storing static information and instructions for processor 204.

Further, a mass storage device 210, such as a magnetic disk drive and/or or a optical disk drive, may be coupled to the computer system 200 for storing information and instructions. The computer system 200 can also be coupled via bus 202 to a display device 234, such as a cathode ray tube (CRT) or a liquid crystal display (LCD), for displaying information to a user so that, for example, graphical or textual information may be presented to the user on display device 234. Typically, an alphanumeric input device 236, including alphanumeric and other keys is coupled to bus 202 for communicating information and/or command the user can selections to processor 204. Another type of user input device show in the figure is a cursor control device 238, such as a conventional mouse, touch mouse, trackball, track pad or other type of cursor direction keys for communicating direction information and command selection to processor 204 and for controlling movement of a cursor on display 234. Although not illustrated, the computer system 200 may optionally include video, camera, speakers, sound card, and many other conventional options. Various types of input devices, including, but not limited to the input devices described herein unless otherwise noted, allow the user to provide command or input to the computer system 200. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input.

A communication device 240 is also coupled to bus 202 for accessing other computer systems, as described below. The communication device 240 may include a modem, a network interface card, or other well-known interface devices, such as those used for interfacing with Ethernet, Token-ring, or other types of networks. In any event, in this manner, the computer system 200 may be coupled to a number of other computer systems via a network infrastructure such as the infrastructure illustrated and described below.

Login

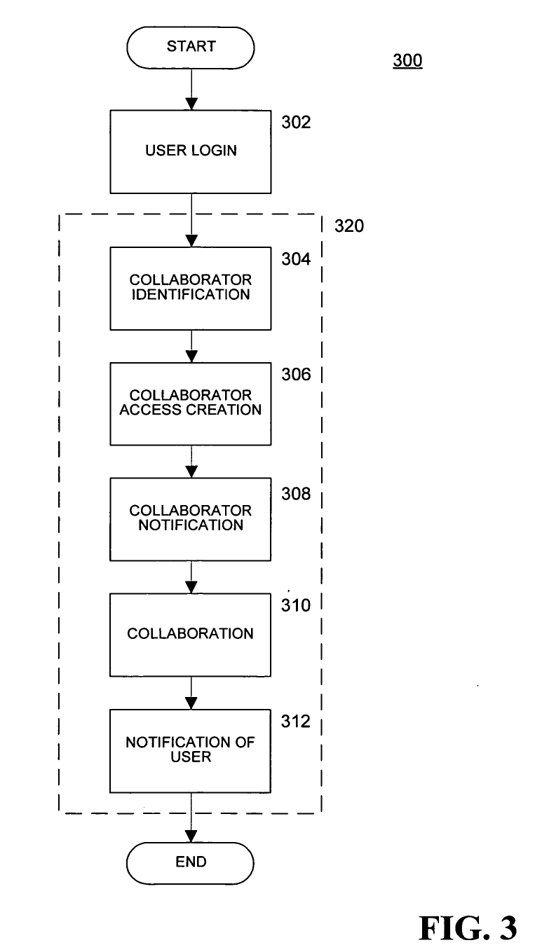

FIG. 3 illustrates an operation of system 100 in the response to an access of the system by user 102. In step 302, as illustrated in FIG. 3, user 102 will log into the insurance marketing and policy management system via a Welcome Screen interface 400 to carry out a specific workflow process. For example, writing a new policy, which is a typical workflow process.

At the Welcome Screen, user 102 will:

1. Input Login Name (“user2”)

2. Input Password

3. Click Login

Once user 102 has logged into the website, in step 304, user 102 will choose a workflow process to complete. User 102 will follow predefined steps of the workflow until they encounter missing data that Collaborator 104 will be required to provide through the steps of Identification, Access Creation, Collaborator Notification and Collaboration, as described below.

Begin Workflow

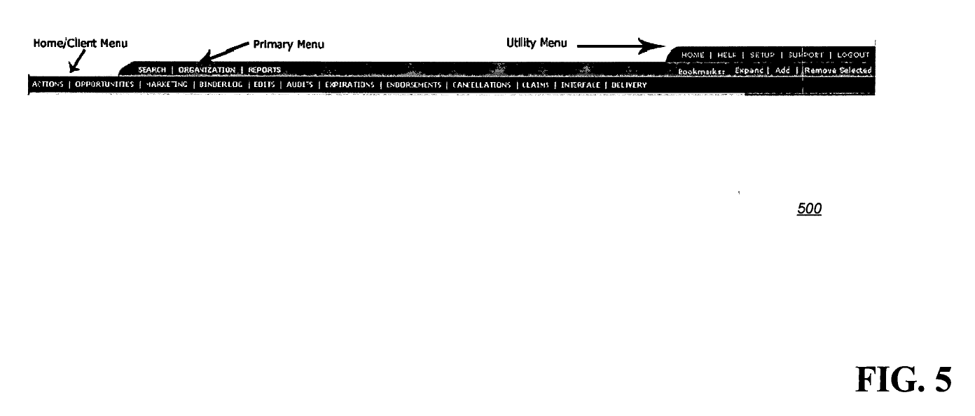

In the following example, as illustrated by workflow 320, the User 102 is an Agent that will choose the Underwriting a Policy workflow process from the Menu Navigation options, shown in FIG. 5.

Identification

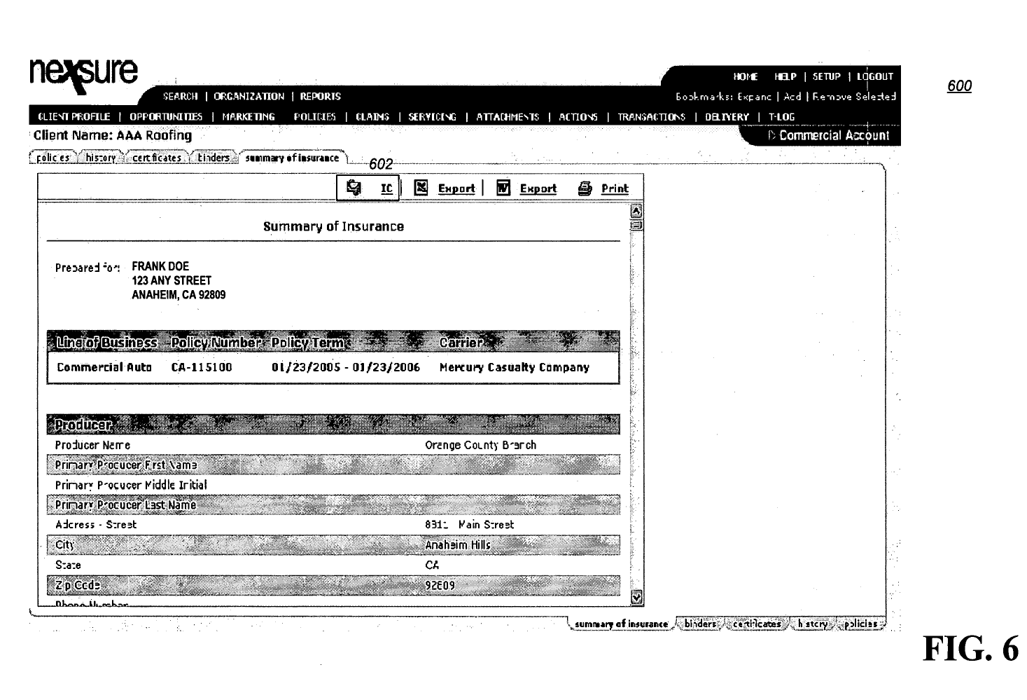

User 102, while engaged in their workflow process, will identify that data is required from Collaborator 104 to complete the process. For example, as illustrated in FIG. 6, a workflow page includes certain fields missing and thus need more data (e.g., “Primary Producer First Name,” “Primary Producer Middle Initial,” and “Primary Producer Last Name”).

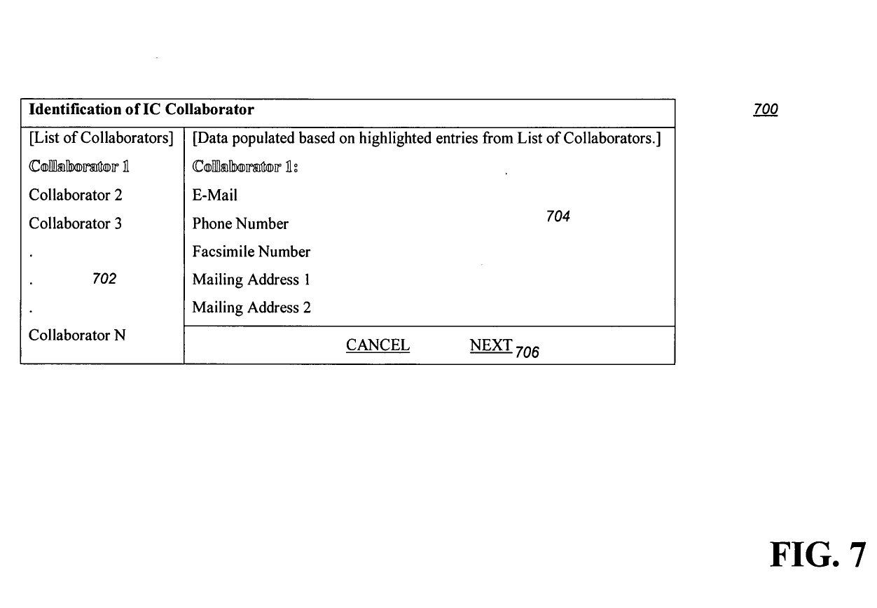

In one the “NIC” icon. In one preferred embodiment, once the user has selected IC icon 602, a pop-up window 700 as shown in FIG. 7 appears that includes an address book 702 on the left, which when the user selects an entry from, the information for User 102 will populate fields on a right portion 704 of the page. A bottom portion 706 of window 700 contains buttons that indicates “Next,” which will take them to the Access Creation screen.

In another preferred embodiment, from within system 100, User 102 will:

1. Complete a search for one or more desired collaborators, which is stored in plurality of databases 112.

2. Upon locating a collaborator, system 100 will open a Card File (i.e., a database record) from plurality of databases 112 that details the contact's information.

3. Click the IC icon, which opens a pop-up window for Access Creation and input of the specific data request. In one preferred embodiment, the information related to determining the various contact methods possible for Collaborator Notification will be stored in system 100 in the Card File.

Access Creation

In step 306, from within system 100, User 102 may create a temporary access login and password to allow the identified Collaborator 104 temporary authentication and login ability system 100. In one embodiment, the Access Creation process adheres to security policies that are inherent to system 100, User 102 and Collaborator 104's specific organization(s). This applies to both conventions in usernames and passwords as well as the limitation of access to specific areas of system 100 as granted by User 102 to Collaborator 104. The temporary access login and password are for limited-time user only as defined by either: Use (e.g., one-time use only) and Time (e.g., validity is limited to timeframe as defined by User 102, such as one week, one month, etc.).

From within system 100, User 102 may:

1. Enters a narrative, detailing the specific information that is required from Collaborator 104 (e.g., the tax identification number of the company).

2. Sets the time limit parameters for the temporary login.

3. Selects specific communication method to be used to contact Collaborator 104.

In one preferred embodiment, the communication method include one or more e-mails, instant messages, and facsimiles to such devices such as computers, Blackberry(™) portable personal digital assistants, and pagers; and the collaborator may be contacted in more than one way. For example, User 102 can select the method(s) of contact using a list of check boxes on a selection panel window on the screen. Once user 102 has selected the method(s) of contact, user 102 may then engage the next step, Collaborator Notification.

Collaborator Notification

In step 308, Collaborator 104 is notified by the specified communication method (email, text message etc.) as selected during Access Creation that their participation is required to complete the process. The communication received will include instructions and a web link (e.g., one-link URL) to allow Collaborator 104 the ability to complete the request through the next step of Collaboration.

Collaboration

In step 310, Collaborator 104 accesses the specific area of the web interface using the provided login and password and inputs requested data. In one preferred embodiment, Collaborator 104 may access system 100 by:

1. Clicking the web link from within their email client. This is a single-click solution by which the provided web link includes all the necessary information to take Collaborator 104 directly to the area in system 100 where they are to complete the requested data entry.

2. Inserting the web link directly into the address bar of an Internet browser. In this method, Collaborator 104 will have to enter the provided username and password as provided in the Collaborator communication.

Once the identification of Collaborator 104 has been verified, collaborator 104 will be placed directly into a web interface 800 where they will carry out the actions required by User 102. In one preferred embodiment, Collaborator 104 will also have the opportunity to insert narrative in response to User 102. Collaborator 104 will not have access to any other parts of the web interface for security purposes. Upon completion of the Collaboration process, Collaborator 104 will:

1. Be presented with a “Process Completed” screen message.

2. System 100 will provide User Notification to User 102 that the Collaboration process has been completed.

User Notification

In step 312, User 102 is notified of the completion of the Collaboration process by Collaborator 104 the specified communication methods as stored in system 100 for User 102. For example, these methods may include E-mail, text messaging and/or the other methods as specified above for Collaborator 104. In one embodiment, the communication received will include the narrative from Collaborator 104 as well as any details related as to the actions taken. User 102 may then continue the steps in their original workflow required for total process completion. In one preferred embodiment, there may be multiple collaborators required to obtain all required data. User 102 would repeat the same process of Identification, Access Creation, Collaborator Notification and Collaboration using system 100 to contact each collaborator.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It should be noted that the methods described herein may be implemented on a variety of communication hardware, processors and systems known by one of ordinary skill in the art. For example, the general requirement for the client to operate as described herein is that the client has a display to display content and information, a processor to control the operation of the client and a memory for storing data and programs related to the operation of the client. In one embodiment, the client is a cellular phone. In another embodiment, the client is a handheld computer having communications capabilities. In yet another embodiment, the client is a personal computer having communications capabilities. The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments described above are exemplary embodiments. Those skilled in the art may now make numerous uses of, and departures from, the above-described embodiments without departing from the inventive concepts disclosed herein. Various modifications to these embodiments may be readily apparent to those skilled in the art, and the generic principles defined herein may be applied to other embodiments, e.g., in an instant messaging service or any general wireless data communication applications, without departing from the spirit or scope of the novel aspects described herein. Thus, the scope of the invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments. Accordingly, the present invention is to be defined solely by the scope of the following claims.

What is claimed is:

1. A method comprising:
identifying data that is needed by a collaborator to complete a workflow process;
creating a temporary access login and password to allow the collaborator temporary authentication and login ability;
notifying the collaborator by a communication method that their participation is required to complete process;
receiving a login and a password from the collaborator to access specific area of and inputs requested data; and,
providing notification of completion of the collaborator by a second communication method.
